(19) United States
(12) Patent Application Publication
(10) Pub. No.: US 2023/0368142 A1
(43) Pub. Date: Nov. 16, 2023

(54) DATA AGGREGATION BASED ON MULTISYSTEM INTEGRATION FOR OBJECT COLLABORATION

(71) Applicant: SAP SE, Walldorf (DE)

(72) Inventors: Rajarshi Ghosh, Mannheim (DE); Simone Turrin, Heidelberg (DE); Petra Eder, Mannheim (DE); Ranjith Kumar Nookala, Tadpatri (IN); Rajat Arora, Bangalore (IN); Tzanko Stefanov, Karlsruhe (DE)

(21) Appl. No.: 17/740,933

(22) Filed: May 10, 2022

(51) Int. Cl. G06Q 10/10

(52) U.S. Cl. CPC G06Q 10/103

(57) ABSTRACT

In some implementations, supporting system collaboration includes actions of generating a digital identifier for a digital object corresponding to a physical object included in an object list formatted for display and including model information retrieved from a second system coupled to the first system, the model information including an identifier of a physical object and one or more characteristics of the physical object, assigning the digital identifier of the digital object to a service to be performed on the physical object, transmitting, to a second system, the digital identifier, the second system performing a service related to the physical object, receiving, to a second system, a service result related to the physical object, and transmitting, to a third system, the service result related to the physical object.

### BACKGROUND

Collaborative projects for object servicing present potential benefits to the entities but involves some risks and reasonable concerns. For example, a poor mechanism of data exchange and data communication can lead to loss of effectiveness and efficiency of data processing by one or more components of the system. As another example, collaborative projects require entities to adapt a common process, which could lead to system incompatibilities.

### SUMMARY

Implementations of the present disclosure include computer-implemented methods for supporting collaborative projects by using a digital object including an object list visible to multiple entities, a portion of the object list corresponding to a service of the digital object. The digital object is usable to provide secure process visibility and secure data sharing between entities of a collaborating multisystem.

According to a first aspect, a method for object collaboration is executed by one or more processors configured to perform actions including: receiving a registration of an account on a first system, adding objects to an object list associated with the account on the first system, publishing the object list to make the object list visible to a plurality of users of the first system, receiving, by the one or more processors and from one of the plurality of users of the first system, a request to export a portion of the object list, conditioning the portion of the object list to be accessible to an third system by converting the portion of the object list based on a transmission protocol, formatting the portion of the object list for display on the third system, and packaging the portion of the object list for transmission to the third system, and exporting the portion of the object list to the third system. The object list is formatted for display by one or more computing devices within the first system and including model information retrieved from a second system coupled to the first system, the model information including an identifier of a physical object and one or more characteristics of the physical object.

In some implementations, a service order including the model information associated with the physical object referenced in the portion of the object list is received.

In some implementations, an advance notice for the service order is generated.

In some implementations, a request to generate a digital object is transmitted to the second system. The request includes at least one of technical specifications of the physical object, digital representation of spare components of the physical object, and recommended services for the physical object.

In some implementations, an identifier of the digital object is assigned for tracking the digital object during a process.

In some implementations, a responsibility of managing and tracking of the digital object is assigned during the process using the identifier of the digital object.

In some implementations, a confirmation of completion of the service order for the physical object referenced in the portion of the object list is received.

The present disclosure also provides a computer-readable storage medium coupled to one or more processors and having instructions stored thereon which, when executed by the one or more processors, cause the one or more processors to perform operations in accordance with implementations of the methods provided herein.

According to a second aspect, a method for object collaboration is executed by one or more processors configured to perform actions including: generating a digital identifier for a digital object corresponding to a physical object included in an object list formatted for display by one or more computing devices within a first system and including model information retrieved from a second system coupled to the first system, the model information including an identifier of a physical object and one or more characteristics of the physical object, assigning, by one or more processors, the digital identifier of the digital object to a service to be performed on the physical object, transmitting, by one or more processors to a second system, the digital identifier, the second system performing a service related to the physical object, receiving, by one or more processors to a second system, a service result related to the physical object, and transmitting, by one or more processors to a third system, the service result related to the physical object.

In some implementations, assigning the service includes: analyzing, by one or more processors, the model information to obtain a data feature corresponding to the model information, and matching the model information based on the data feature to determine target service information that matches the digital identifier.

In some implementations, the model information is visible for first system users and second system users.

In some implementations, the operations further include transmitting, by the one or more processors to the second system, a request to generate the digital object corresponding to the physical object.

In some implementations, the operations further include tracking the digital object during a process by using the digital identifier.

In some implementations, the operations further include assigning a responsibility of managing and tracking of the digital object during the process using the identifier of the digital object.

In some implementations, the operations further include linking the digital object to the physical object received by an entity of the first system to generate a service notice.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 is a schematic illustration of an example system architecture in accordance with implementations of the present disclosure.

FIG. 2 is an example of a functional block diagram of an example multisystem in accordance with implementations of the present disclosure.

FIG. 3 is an example of a work flow diagram in accordance with implementations of the present disclosure.

FIG. 4 depicts information flow in accordance with implementations of the present disclosure.

FIGS. 5A and 5B depict example processes in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are generally directed to providing collaborative projects in a multisystem, including a cloud environment. More particularly, implementations of the present disclosure are directed to integrated and risk-regulated data flow control in cloud environments that support secure and compliant data flow between entities of collaborative projects. In general, implementations of the present disclosure build on support for collaborative projects with long-term processes (e.g., logistics). In some implementations, such collaborative projects can include a flexible process that can be changed in an ad-hoc manner, entities that can be ad-hoc invited and bound to certain roles in the collaborative project, and entities that can share relevant data of the collaborative project (e.g., shared data).

Implementations of the present disclosure are generally directed to service collaborations, in which entities collaborate to add, update, and access object descriptions of an object list to request and monitor a service related to a physical object by using a respective digital object. In some implementations, the object description can include a data set. In some implementations, object descriptions are provided through the creation of designs and the corresponding implementations. Consequently, deliverables of the collaborative work can be provided in the form of one or more physical objects corresponding to engineering data sets described in the object list. Implementations of the present disclosure address how and in which manner to provide an integrated view of the engineering data sets and process visibility during a requested service between entities accessing different systems. This is referred to as data aggregation for process visibility within the present disclosure. Implementations of the present disclosure also address how and in which manner to improve data sharing based on display requirements, usage control policies and risk assessment. In some implementations, the risk assessment includes a risk factor that reflects a degree of risk if the data is able to freely flow to the receiving applications of a particular system. In some implementations, the data flow control system can fully block, partially grant (partially block) or fully grant the receiving application access to the data. In some implementations, partially granting (partially blocking) access to the data can include formatting the data and sanitizing the data to provide formatted sanitized data, such that the receiving application receives the formatted sanitized data (e.g., in lieu of the original data).

Implementations of the present disclosure will be described in view of an example context. The example context includes real-time tracking and management of services using digital objects. In some implementations, a retail enterprise can update an object list to add services available for end users (e.g., customers). For example, an end user can have a computing device that can execute a client-side application. The client-side application the object list and can access a detailed technical description of each object listed in the object list without having to access a separate application. A service related to a selected object, can be viewed in real-time by users of multiple systems (including providers, customers, collaboration platforms, and database engines) and can be managed using an application that can be hosted on a backend system (e.g., on the cloud). The client-side application can communicate with the management application using a digital object and its respective identifier. In some implementations, the backend system is provided by a service provider (e.g., a cloud service provider).

As discussed in further detail herein, implementations of the present disclosure provide integrated and risk-controlled data flow. Implementations of the present disclosure can be provided in cloud environments that support secure, compatible, and compliant data flow between hosted applications. In some implementations, the cloud environment hosts applications that can communicate with one another. For example, an application can access services provided by one or more third-party applications. In the example context, the management service can access services, such as tracking and tracing services, provided by one or more third-party developers. In some implementations, applications hosted in the cloud environment can be accessible from various end user devices over a network.

In some implementations, the cloud environment can be designed to include risk-based data flow control to enable secure data flow between multiple applications. In some implementations, particular security policies (e.g., access control) might be required for a particular application. In some implementations, security policies for a particular application can be associated with the risk of data flowing between applications against the security policy. In some implementations, the cloud environment can reference the security policies required by the application owners and allow third parties to subscribe to one or more applications providing risk-based data flow control.

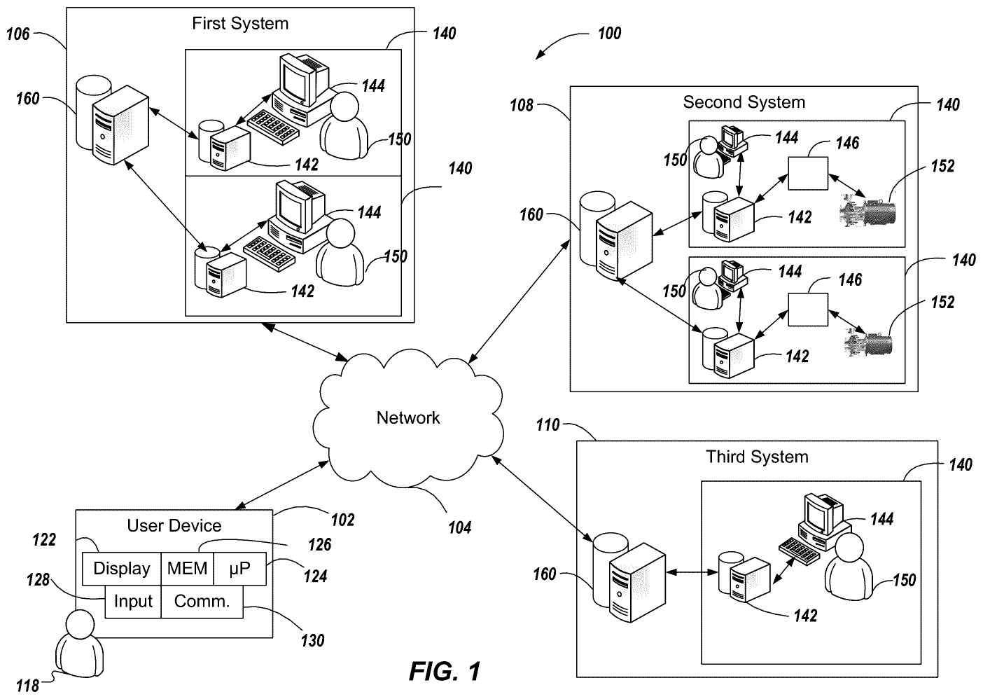

Implementations of the present disclosure will be described in further detail herein within an example context of example forms of service collaborations. More specifically, and with reference to FIG. 1, simplified example forms of service collaborations are provided. In view of this context, the present disclosure provides collaboration requirements for integrated visibility and risk constricted data sharing. It is appreciated, however, that the example forms of service collaborations provide the example context within which implementations of the present disclosure are discussed. Implementations of the present disclosure are readily applicable in other contexts with other forms of service collaboration.

Referring now to FIG. 1, an example system architecture 100 is illustrated. The example system architecture 100 includes a user device 102, a network 104, a first system 106, a second system 108, and a third system 110. As discussed in further detail herein, data is transferred from each of the first, second, and third systems 106, 108, 110 through the network 104 for presentation, or display on the user device 102 or any other user device 144 integrated within one of the first, second, and third systems 106, 108, 110. Further, data can be transferred from the user device 102 through the network 104 to each of the first, second, and third systems 106, 108, 110. Although a single user device 102 is illustrated, it is contemplated that one or more user devices 102 can communicate with each of the first, second, and third systems 106, 108, 110 through the network 104. Similarly, although three systems 106, 108, 110 are illustrated, implementations of the present disclosure can include one or more systems.

The user device 102 can include any number of example devices. Such example devices include, but are not limited to, a mobile phone, a smartphone, a tablet computing device, a personal digital assistant (PDA), a laptop personal computer (PC), a desktop PC, and/or appropriate combinations thereof In the depicted example, the user device 102 includes a display 122, a processor 124, memory 126, an input interface 128, and a communication interface 130. The processor 124 can process instructions for execution of implementations of the present disclosure. The instructions can include, but are not limited to, instructions stored in the memory 126 to display graphical information on the display 122. Example displays include, but are not limited to, a thin-film-transistor (TFT) liquid crystal display (LCD), or an organic light emitting diode (OLED) display. The memory 126 stores information within the user device 102. In some implementations, the memory 126 can include a volatile memory unit or units, and/or a non-volatile memory unit or units. In other implementations, removable memory can be provided, and can include, but is not limited to, a memory card. Example memory cards can include, but are not limited to, a secure digital (SD) memory card, a mini-SD memory card, a USB stick, and the like.

In some implementations, the input interface 128 can include a keyboard, a touchscreen, a mouse, a trackball, a microphone, a touchpad, and/or appropriate combinations thereof. In some implementations, an audio codec (not shown) can be provided, which receives audible input from a user or other source through a microphone, and converts the audible input to usable digital information. The audio codec can generate audible sound, such as through a speaker that is provided with the user device 102. Example sounds can include sound from voice telephone calls, recorded sound (e.g., voice messages, music files, etc.), and/or sound generated by applications operating on the user device 102.

The user device 102 can communicate with the network 104 through a connectivity interface(s). In some implementations, the connectivity interface(s) can include a satellite receiver, cellular network, a Bluetooth system, a Wi-Fi system (e.g., 802.x), a cable modem, a DSL/dial-up interface, a private branch exchange (PBX) system, and/or appropriate combinations thereof. Each of these connectivity interfaces 104 enables data to be transmitted to/from the network 104. In some implementations, the network 104 can be provided as a local area network (LAN), a wide area network (WAN), a wireless LAN (WLAN), a metropolitan area network (MAN), a personal area network (PAN), the Internet, and/or combinations thereof.

Systems 106, 108, 110 can include, but are not limited to, a server system, a procurement system, an asset intelligence system, an enterprise resource planning system, a logistics system, a manufacturing system, and an asset service system. In the example systems of FIG. 1, the first system 106, and the second system 108 include a plurality of facilities 140, and the third system 110 includes a facility 140. It is contemplated that each system 106, 108, 110 can include one or more facilities, and is not limited to the example arrangement described herein. In the case of multiple facilities, the facilities can be remotely located from one another, and/or can be located at a common location, or site (e.g., separate departments in a common (the same) building). Each system 106, 108, 110 can be provided as an asset manufacturing or handling system, and the like.

In some implementations, each facility 140 includes an associated information system 142, computer interface(s) 144, and asset monitoring device(s) 146. Each information system 142 can be provided as a server (e.g., a front-end server, a back-end server, a cloud server), and supports the acquisition, storage, modification, and distribution of asset information, such as asset data, throughout the facility 140 and/or systems 106, 108, 110. Although the example system architecture 100 includes an information system 142 located at each facility 140, it is contemplated that the facilities 140 can communicate with a common information system 142 that is remotely located from either facility 140, or that is located at one of the facilities 140 within the systems 106, 108, 110.

In some implementations, the computer interface 144 can include a personal computer (PC) (e.g., desktop, laptop, or tablet). Although a single computer interface 144 is illustrated in the example architectures described herein, it is contemplated that one or more computer interfaces 144 can communicate with the information system 142. Communication between each computer interface 144 and the information system 142 can be achieved via a direct connection, or remotely through a network (not shown) that can include, but is not limited to, a LAN, a WAN, a WLAN, and/or the Internet.

In some implementations, each asset-monitoring device 146 monitors characteristics of a particular physical asset (object) 152, and generates data signals based thereon. As discussed in further detail herein, implementations of the present disclosure provide monitoring devices 146 that include a computing device, such as a tablet-computing device. The data signals are communicated to the information system 142, which collects data based thereon, and stores the data to a record that is associated with the particular asset. An example asset record can include an electronic record. Although a single asset monitoring device 146 is illustrated per each asset 152, it is contemplated that multiple asset monitoring devices 146 can monitor a particular asset 152. The asset monitoring device(s) 146 can communicate with the information system 142 via a direct connection, or remotely through a network (not shown) that can include, for example, a LAN, a WAN, a WLAN, and/or the Internet.

In some implementations, the asset data is made available for display on the computer device 144. A user 150 (e.g., specialist, engineer, manager or handler) can augment the asset data by inputting asset information that is also stored to the information system 144. More specifically, the user 150 can input asset information corresponding to a particular asset 152, which asset information can be stored to the asset record. As one example, an engineer can input manufacturing notes, which manufacturing notes can be stored to the asset record in the information system. Example asset information can include any sensor detected or human generated information corresponding to an asset.

As discussed above, each information system 142 stores asset data that can be collected from the asset monitoring devices 146, as well as additional asset information, that can include information that is input by an asset handler. The information system 144 communicates the asset data and/or the additional asset data to a data management system 160. The data management system 160 can be provided as a server, or a virtual server, that runs server software components, and can include data storage including, for example, a database and/or flat files. In the example system architecture 100 of FIG. 1, each system 106, 108, 110 include a corresponding data management system 160. In such an arrangement, each information system 142 communicates asset data, and/or additional asset data to the data management system 160. Furthermore, and as discussed in further detail below, the data management system 160 can communicate ancillary information to the information system 142. Communication between the data management system 160 and the information system(s) 142 can be achieved via a direct connection, or remotely through a network (not shown) that can include, for example, a LAN, a WAN, a WLAN, and/or the Internet.

In some implementations, a data management system 160 corresponding to a particular system can be remotely located from any of the facilities 140 of the system 106, 108, 110, or can be located at a particular facility 140 of the system 106, 108, 110. In the example system architecture 100 of FIG. 1, the data management system 160 is remotely located from either facility 140 within each of the systems 106, 108, 110. It is contemplated, however, that the data management system 160 can be located at one of the facilities 140, and remote from the other facility 140. For example, the data management system 160 can be hosted by a third-party vendor (e.g., a cloud service provider). In some implementations, each information system 42 communicates with the data management system 160 via a direct connection, or remotely through a network (not shown) that can include, but is not limited to, a LAN, a WAN, a WLAN, and/or the internet.

In the example system architecture 100 of FIG. 1, the facility 140, or system 106, 108, 110 installs the data management system 160 as a local data management system 160 that sits at the local site with other servers that can include, for example, the information system 142. In some implementations, the data management system 160 can be sectioned off, or separated from a logical network perspective, but still physically exists with the other servers that belong to the respective facility 140. In some implementations, server components are installed on the data management system 160, which components can include, for example, a database component, a database synchronization component, a web services component, and/or a structured query language (SQL) component. In some implementations, the data management system 160 can be arranged in a multiple server configuration, in which one server only hosts web service related components and is logically segregated, and another server has the remaining necessary server components installed.

In some implementations, the user device 102 and the computer interface 144 can communicate with the information system 142 by using applications that are executed on a client-server architecture to enable access to information that is stored within, and managed by the information system 142. The example context includes applications that can be executed on a client-server architecture, such as the example system architecture 100 of FIG. 1. In some implementations, the applications can be provided in a suite that includes two or more applications. Example applications can include an enterprise resource planning (ERP) application, a customer relationship management (CRM) application, a supply chain management (SCM) application, and a product lifecycle management (PLM) application. It is contemplate, however, that implementations of the present disclosure can be realized in any appropriate context, e.g., healthcare applications. Referring again to FIG. 1, and in the example context, one or more applications can be hosted by a server system (e.g., first system 106). A user 118, 150 can interact with an application using the user device 102. More specifically, a session can be established between the user device 102 and one or more server devices 144, during which session the user 118 is able to interact with one or more applications hosted on the server system. The one or more applications can enable the user 118, 150 to interact with data stored in one or more databases. In some implementations, interactions can result in data being created and stored to the database, deleted from the database, and/or edited within the database.

In some implementations, the data management system 160 (e.g., back end server) is modified, to separate database queries from other application code and user interface. One such architecture includes the Fiori framework for web applications provided by SAP SE of Walldorf, Germany. In the Fiori framework, the web application is largely executed as JavaScript in the web browser. The user interface components (e.g., images) and design (as well as other resources) are downloaded as HTML and CSS integrated with the JavaScript code. In order to persistently store and process data on the cloud server, the client issues requests (e.g., OData requests), which are processed by a database engine (e.g., SAP S/4HANA, Ariba Mobile, and SAP Hybris Cloud for Customer provided by SAP SE of Walldorf, Germany). In some implementations, the requests are translated into queries (e.g., SQL queries) for the back-end database of any of the systems 106, 108, 110. The user device 102 can process the query responses and can display the query responses including asset information, using a dynamically created HTML.

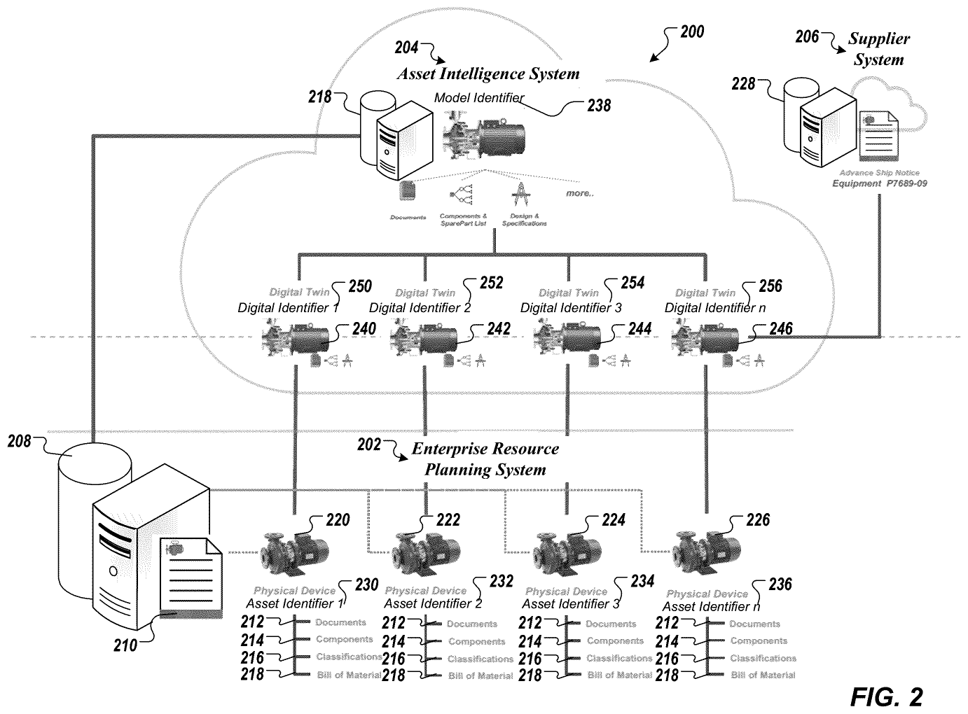

In some implementations, the example system architecture 100 can be used for service collaboration between manufacturing, planning, and tracking organizations, each system 106, 108, 110 corresponding to a different organization. In the example of FIG. 1, each organization is depicted as owning its own data. In order to collaborate, data and major notifications are exchanged by means of some communication mechanism (described with reference to FIGS. 2-4). In some implementations, advanced mechanisms can be used for data exchange, such as engineering data exchange tools (e.g., PDTec's tool “ICE.net”). In some implementations, less advanced mechanisms can be used (e.g., e-mail).

The communication-based collaboration can include a service collaboration. An example issue for this form of service collaboration includes issues related to the visibility and agility of a process related to an asset. For example, a first entity can perform a first operation and a second entity can perform a second operation, working together to complete a service requested by a third entity that performs a third operation. However, the third entity might require to be aware of the real-time status of the joint work of the first and second entities. In some implementations, an entity (e.g., the customer) might need to adapt the process involving an asset, thus requiring an extra entity to control the results of the first entity and the second entity. Another example issue includes that, given that some data exchange mechanisms are applied, each group of entities needs to solve the data exchange mechanisms again and again between themselves. Another example issue includes that, when communication is achieved through e-mail, it can be very difficult to keep data synchronized with the communication. In view of at least these example issues, process-based collaboration with data sharing based on digital assets can provide a viable and an efficient solution for supporting multisystem collaborative (servicing, manufacturing, and/or engineering) projects.

FIG. 2 illustrates an example of a functional block diagram of an example multisystem platform 200 in accordance with implementations of the present disclosure. The multisystem 200 can be configured for process-based collaboration with data sharing based on digital assets corresponding to physical assets. The multisystem 200 includes an enterprise resource planning system 202, an asset intelligence system 204, and a supplier system 206.

The enterprise resource planning system 202 can include a master materials requirements planning (MRP) module 208 configured to manage asset information 210 including documents 212, components 214, classifications 216, and bills of materials (BOM) 218 for a plurality of physical assets (devices) 220, 222, 224, 226. The BOM 218 can include a list of components (e.g., raw materials, sub-assemblies, intermediate assemblies, parts) needed to assemble and manufacture a finished product or a product type. The BOM 218 can include an asset identifier 230, 232, 234, 236, a component name, the quantities of each component needed to manufacture the finished product and the supply chain source for the component. For example, BOM 218 can be represented as a hierarchical structure with top level representing the finished product, and lower levels representing sub-assemblies that may include the addition of components. A BOM explosion breaks apart each assembly or sub-assembly listed in the BOM into its component parts. In some implementations, the enterprise resource planning system 202 can use integrated product and process (e.g., iPPE by SAP AG) to maintain master data needed to create and maintain a BOM 218 for each physical asset 220, 222, 224, 226.

The enterprise resource planning system 202 can perform material requirements planning for a manufacturing process or parts procurement process requested by the asset intelligence system 204 for the manufacture or service of a physical asset 220, 222, 224, 226. Material requirements planning can take into consideration existing enterprise stock levels, and existing purchase and production orders using defined planning rules. In the example of FIG. 2, the master MRP module 208 (e.g., SAP MRP software manufactured by SAP AG) can perform centralized material requirements planning for all enterprise manufactured physical asset 220, 222, 224, 226.

The asset intelligence system 204 can communicate (over a network) with the enterprise resource planning system 202 to enhance asset selection and to increase visibility of asset services using an automatically updated asset information using a direct correspondence between physical assets 220, 222, 224, 226 and respective digital assets 240, 242, 244, 246. The physical assets 220, 222, 224, 226 can be identified using assets identifiers 230, 232, 234, 236 that are mapped to respective digital assets identifiers 250, 252, 254, 256 of the digital assets 240, 242, 244, 246.

The asset intelligence system 204 can retrieve, from the enterprise resource planning system 202, documents 212, components 214, classifications 216, and bills of materials (BOM) 218 for a plurality of digital assets 240, 242, 244, 246 corresponding to the physical assets (devices) 220, 222, 224, 226. The asset intelligence system 204 can communicate with the supplier system 206 to use supply chain planning applications that can increase the system's overall knowledge of the supply chain and can also provide forecasting, planning and optimization functions for the digital assets 240, 242, 244, 246.

The enterprise resource planning system 202 and the asset intelligence system 204 can implement a service-oriented architecture based on digital assets 240, 242, 244, 246. Interoperable services within the service-orientated architecture can allow different applications included in the asset intelligence system 204 and the enterprise resource planning system 202 to exchange data with one another. The services can be accessible over an internal enterprise network or a network that can allow communication with applications outside of the internal enterprise network. The services can communicate by passing data from one service to another or by coordinating an activity between two services using the link between digital assets 240, 242, 244, 246 and the physical assets 220, 222, 224, 226. The use of a service-oriented architecture in the enterprise resource planning system 202 and the asset intelligence system 204 can allow for efficient and secure communication between system modules. A central computing device can use a service in the service-oriented architecture to provide data from one module of a first system to another module of a second system in the multisystem platform 200. For example, a computing module 218 of the asset intelligence system 204 can use a service in the service oriented architecture to provide data from one module in the enterprise resource planning system 202 (e.g., master MRP module 208) to another module located in a supplier system 206 that can include one or more computer devices.

In some implementations, the asset intelligence system 204 may use a combination of common parts (e.g., a collection of parts used in the manufacture of a plurality of physical assets 220, 222, 224, 226) and specific parts (e.g., parts used for a small subset or only one of the plurality of physical assets 220, 222, 224, 226) to manufacture a physical asset 220, 222, 224, 226 and track in real time the manufacturing process of the physical asset 220, 222, 224, 226 using the respective digital assets 240, 242, 244, 246. The combination of common parts may be referred to as a platform. For example, a product manufacturing enterprise system may require the use of thousands of parts to assemble a physical asset 220, 222, 224, 226. The enterprise may use a platform design for the physical asset 220, 222, 224, 226 in which the platform may include one thousand parts. The enterprise can use the one thousand common parts to manufacture a series of physical asset 220, 222, 224, 226, each being tracked separately using its unique identifier of corresponding digital asset 240, 242, 244, 246. Remaining specific parts may include optional accessories (e.g., a navigation system) that can be included in one or more particular physical asset 220, 222, 224, 226.

In the enterprise resource planning system 202, the master MRP module 208 can perform centralized material requirements planning. The master MRP module 208 can be responsible for the planning and procurement of common materials and parts (e.g., the platform) used to assemble a plurality of products manufactured at one or more manufacturing plants. For example, and in contrast, a local MRP module in the enterprise resource planning system 202 can provide asset information corresponding to a single physical asset 220, 222, 224, 226. Material requirements planning in the in the enterprise resource planning system 202 for the procurement of materials and parts are specific to the physical asset 220, 222, 224, 226 manufactured at a manufacturing plant. Using a distributed material requirements planning process can balance the use of centralized planning processes with local manufacturing plant specific planning processes for material requirements planning. The processes can involve managing the master data for the BOM, and enabling individual tracking of each of the physical assets 220, 222, 224, 226 during planning processes and purchasing processes using the corresponding digital assets 240, 242, 244, 246.

In some implementations, the asset intelligence system 204 can consolidate asset information for all asset types, retrieving data from the enterprise resource planning system 202 and the supplier system 206 and formatting it to enable visualization through an application of the asset intelligence system 204. Data consolidation can optimize the asset tracking process using the links between the digital assets 240, 242, 244, 246 and the physical assets 220, 222, 224, 226 to retrieve, process, update and share asset information in real time. In addition, data consolidation can optimize the purchasing process because a customer can access all relevant information from an asset catalog (listing all available assets) to detailed technical descriptions using a single application, without having to switch between multiple applications corresponding to multiple systems responsible for the purchase orders, parts management and interaction with the parts vendor for a large quantity of parts. In the example system architecture 100, the central location 102 can be responsible for the planning and procurement of the common parts used in the platform design. Centralized common parts management can keep common parts used for a platform standardized for the platform.

In some implementations, a computing module 228 of the supplier system 206, can connect any of the product repositories to asset intelligence system 204 or directly importing them using a table based upload functionality. The upload functionality of the asset intelligence system 204 can help suppliers (users of the supplier system 206) to publish services for physical assets 220, 222, 224, 226 and link the services to the corresponding digital assets 240, 242, 244, 246 that are relevant for and finally promote discovery for potential customers on the multisystem platform 200.

The asset intelligence system 204 can be configured to facilitate integration capabilities with different digital marketplaces such that users of the supplier system 206 can leverage to commercialize services for physical assets 220, 222, 224, 226. The asset intelligence system 204 can be configured to enable buyers (operators of the asset intelligence system 204) to discover the appropriate models, spares, and services with advance comparison and smart matching capabilities (e.g., including machine learning optimized searches) across a network of supplier systems 206 and coordinate execution of a selected service for a selected physical asset 220, 222, 224, 226 into their backend system. The asset intelligence system 204 can be configured to enhance a service setting and tracking experience by enabling users of the supplier system 206 to send the digital assets 240, 242, 244, 246 (corresponding to the selected physical asset(s) 220, 222, 224, 226) through asset intelligence system 204 along with or even before the physical asset(s) 220, 222, 224, 226 is created for the customer. The transmission of the digital assets 240, 242, 244, 246 (corresponding to the selected physical asset(s) 220, 222, 224, 226) with complete and up-to-date (real-time updated) asset information can enable performance of a quality control, by buyers (operators of the asset intelligence system 204), before receiving the physical asset(s) 220, 222, 224, 226. The buyers (operators of the asset intelligence system 204) can fully review specific materials, components, documents, and classifications of the physical assets 220, 222, 224, 226 assigned to a manufacturing plant or servicing plant of the enterprise resource planning system 202. Local material requirements planning can result in improved manufacturing processes and product quality as the responsibility for the finished product is at a smaller, decentralized level closer to the physical manufacturing process that may have the best knowledge about the particular part.

The asset intelligence system 204 can use a machine-learning algorithm to determine which components in the central hosted master data BOM of a digital asset corresponding to a physical asset available through the enterprise resource planning system 202 are matching specific parts requested by a buyer (operator of the asset intelligence system 204). The machine-learning algorithm can provide the filtered search result data to the master MRP module 218 to retrieve a corresponding model identifier 238. In some implementations, the asset intelligence system 204 can classify the filtered search result data based on feedback from the buyers. In some implementations, portions of filtered search result data can be flagged to indicate a confirmed match between requested components of the physical assets 220, 222, 224, 226 that were previously searched by buyers (operators of the asset intelligence system 204). The asset intelligence system 204 can consolidate and rank all of the identified search results and can format any document retrieved from another system to facilitate transmission and display.

The enterprise resource planning system 202 can manage the complete orders for each physical assets 220, 222, 224, 226 it manufactures or services. In some implementations, a complete planned order object can be stored in the enterprise resource planning system 202. The planned order object can include a list of documents 212, components 214, classifications 216, and bill of material 218 of the physical asset 220, 222, 224, 226. The enterprise resource planning system 202 can use the planned order object to generate the digital asset and manufacture the physical asset 220, 222, 224, 226. During the manufacturing process or the asset service process, changes to the physical asset 220, 222, 224, 226 can occur prior to the manufacture of the finished physical asset 220, 222, 224, 226 but after the receipt of the initial order for the product. For example, an engineering change notice can be generated by the enterprise resource planning system 202 for the physical asset 220, 222, 224, 226, triggering an automatic update of the digital assets 240, 242, 244, 246. The changes may affect components or specific parts needed for the manufacture of the physical asset 220, 222, 224, 226.

In some implementations, the asset intelligence system 204 can receive the engineering change notice from the enterprise resource planning system 202. The asset intelligence system 204 can update the master data for the BOM with the change and the asset information of the digital assets 240, 242, 244, 246. For example, a central computer device or a manufacturing computer device can incorporate the change into the planned order by modifying the order to include a new part, change an existing part or remove an existing part of the digital assets 240, 242, 244, 246. The change can also be made to the planned order object to be reflected in the manufacture of the physical asset 220, 222, 224, 226.

The asset intelligence system 204 can consolidate the material and parts procurement processes by centrally managing the gross demand on the finished product and the parts stock level for the finished product. The enterprise resource planning system 202 can manage the logistics execution (e.g., the assembly of the finished product). The asset intelligence system 204 can organize the purchasing of all components (e.g., common parts and specific parts) from suppliers. The asset intelligence system 204 can be responsible for the distribution of all components to the specific manufacturing plants.

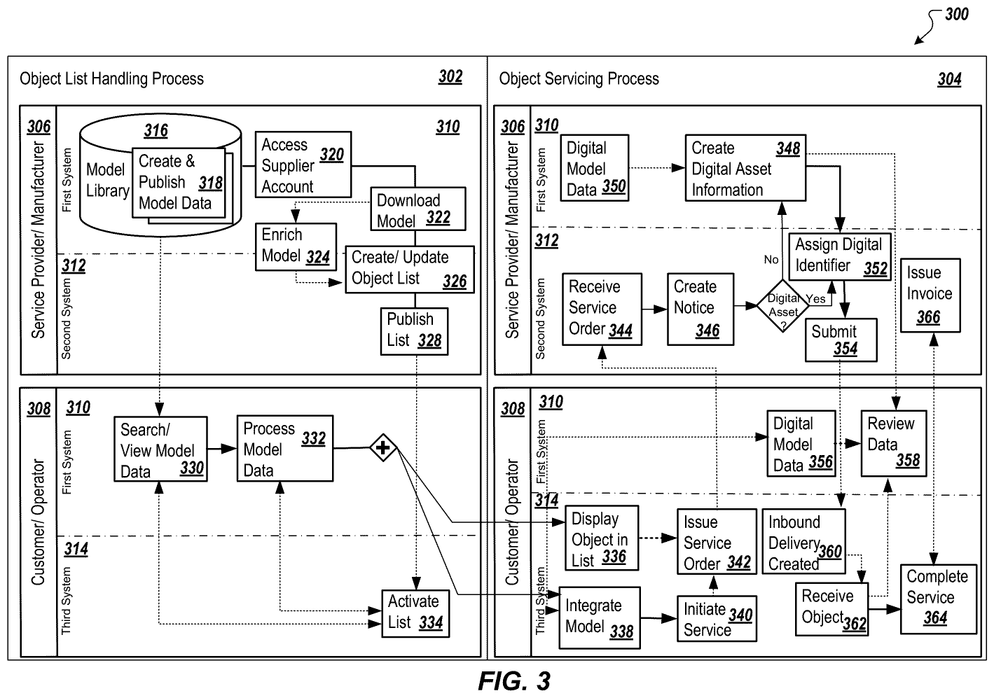

FIG. 3 depicts an example work flow diagram 300 for multisystem collaboration with integrated process visibility and integrated data visibility in accordance with implementations of the present disclosure. The example work flow diagram 300 includes two main workflow components: object (asset) list handling process 302 and object (asset) servicing process 304. As illustrated in FIG. 3, portions of both workflow components 302, 304 can be performed by a service provider or manufacturer 306 and a customer or operator 308.

In some implementations, the manufacturer 306 includes an original equipment manufacturer (OEM). For example, the manufacturer 306 can include an organization whose goal is to design and manufacture a physical asset (e.g., a vehicle, a computing device, a medical device, a self-controlled device, etc.). The manufacturer 306 is responsible for formulating main requirements, purchasing, planning, and producing the final results (physical asset). In some implementations, due to the complexity and the size of the manufacturing process, portions of the manufacturing process are delegated by the service provider or manufacturer 306 to be performed by one or more other entities (companies). In this case, the service provider or manufacturer 306 defines tasks and sets deadlines to orchestrate the entire manufacturing process.

The service provider or manufacturer 306 can be configured to perform operations involving communication between a first system 310 and a second system 312. The customer or operator 308 can be configured to perform operations involving communication between a first system 310 and a third system 314. For example, a representative (e.g., product manager) of the service provider or manufacturer 306 can access the first system 310 (e.g., asset intelligence network (AIN) system 204 described with reference to FIG. 2). The representative of the service provider or manufacturer 306 can access a model library 316 stored in a database of the first system 310 to create and publish model information 318 (technical specifications) corresponding to an asset to be manufactured or serviced by the service provider or manufacturer 306.

The representative of the service provider or manufacturer 306 can generate a user input for the first system 310 to indicate that the asset is ready to be commercialized. In response to receiving the indication that the asset is ready to be commercialized, it is determined whether the service provider or manufacturer 306 has a registered user account in the second system 312 (e.g., procurement system, such as Ariba Network including a database engine, such as Ariba Mobile provided by SAP SE of Walldorf, Germany). In some implementations, a new user as supplier account can be created for the service provider or manufacturer 306 to enable access to the second system 312, as a supplier.

Accessing the supplier account 320 can enable the service provider or manufacturer 306 to download a model 322 corresponding to the asset that is ready to be commercialized. For example, the representative of the service provider or manufacturer 306 can download models from the first system 310 as an asset information table that can be formatted to link the asset to a model, to enter basic asset information details, manufacturer part number, and supplier part identifier (e.g., model identifier 238 described with reference to FIG. 2). The representative of the service provider or manufacturer 306 accessing the first system 310 can collaborate with a specialist (e.g., regional sales executive) of the second system 312 to enrich the model 324. For example, the model can be enriched by adding pricing and lead-time information to the asset information table. The specialist of the second system 312 can use the asset information table to create an object list or to upload the asset information table to an existing object list 326. The object list can be published by the second system 312. For example, the second system 312 can be configured to trigger automatic publication of new or updated object lists.

In some implementations, the model library 316 is shared with a customer or operator 308 accessing the first system 310. The model library 316 can be accessed to search and view model information 330. In some implementations, the first system 310 can be configured to process a model information 332. For example, the first system 310 can process a search query entered by the customer or operator 308 or a result of the model library search, by using a predetermined search algorithm (e.g., a machine learning algorithm) and past-confirmed selections of the customer or operator 308. The algorithm can be configured to evaluate available models in the model library 316 using information (prince and/or lead-time) received from the third system that activated the list 334 that was published by the second system 312. The activation of the list includes list formatting for import, approval, and/or an activation of the list content (e.g., supplier asset intelligence network catalog can be formatted as a procurement catalog for asset selection and purchasing). The algorithm can be configured to evaluate available models to select a matching model for a service (e.g., purchase, repair or modify).

The processing result (model identification) can be displayed 336 by a computing device of the third system. For example, a model identifier of the model matching the search query, can be used to navigate to a catalog item for selecting service requirements (e.g., guided buying for indirect procurement in Ariba Network). The processing result (model identification) can be used to integrate model details 338 to material and bill of materials to an enterprise resource planning system (e.g., enterprise resource planning system 202 described with reference to FIG. 2). The integration result can be used with the Manufacturer Part Number to initiate the service 340 (e.g., procurement process). In response to service initiation 340, a service order is issued 342 by the third system 314. The issued service order is transmitted by the third system 314 to a second system 312 accessible by the service provider or manufacturer 306.

The second system 312 receives the service order with model information 344 and uses the service order to generate an advanced shipping notice 346. The second system 312 can be configured to determine whether digital asset information exists. In response to determining that digital asset information does not exist, the second system 312 transmits a request to the first system 310 to generate digital asset information. In response to receiving the request generate digital asset information 348, the first system 310 can model technical specification to generate model data for the digital asset 350, as described with reference to FIG. 2. The model data for the digital asset can be used by the first system 310 to create digital asset information 348 including a detailed technical specification of the digital asset. The digital asset information can be transmitted, by the first system 310 to the second system 312, to assign a digital identifier to the advance shipping notice corresponding to the digital asset 352. The advance shipping notice is submitted by the second system 312 to the third system 314, to create an inbound delivery notice 360.

In some implementations, the first system 310 submits the digital model data 356 to be displayed for a customer or operator 308, to perform a review of the digital model data 358. In some implementations, the review process, can enable a review of the result of the serviced physical asset using the information of the digital asset to ensure that the technical specifications satisfy the requirements of the ordered service. In some implementations, a portion of the review process is performed by the first system 310, in response to receiving a confirmation from the third system 314 that the object (physical asset) was received 362. The third system 314 can be configured to generate a receipt that can be transmitted to the second system 312, to issue an invoice 366. The invoice can be transmitted to the third system 314 to be verified by the third system 314. In response to receiving a confirmation that the serviced asset satisfies the service criteria and the invoice is correct a service completion notice (e.g., issue payment) can be generated by the third system 314.

As discussed, implementations of the present disclosure provide service structures with embedded workflows, delegation of tasks between multiple systems connected through a communication network, data formatting for increased visibility for users of any of the systems, improved service selection using predetermined algorithms, improved data visibility throughout the service using digital assets, and process-controlled quality using the digital assets. In some implementations, the project structures provide the basis for both data sharing and process-based collaboration. In some implementations, simple delegation enables a resource (e.g., team, person, entity organization) to take over the responsibility for executing a project for the selected service, a sub-project and/or a task. The decoupling between project ownership and project sharing enables organizations to own projects, but still enable other entities to do work on the projects. In some implementations, project-to-entity delegation enables entities (e.g., external entities) to create their own projects in order to handle their responsibility for a specific task owned by a delegating entity. In some implementations, process-controlled versioning supports integration between project delegation or project iteration and the corresponding data handling.

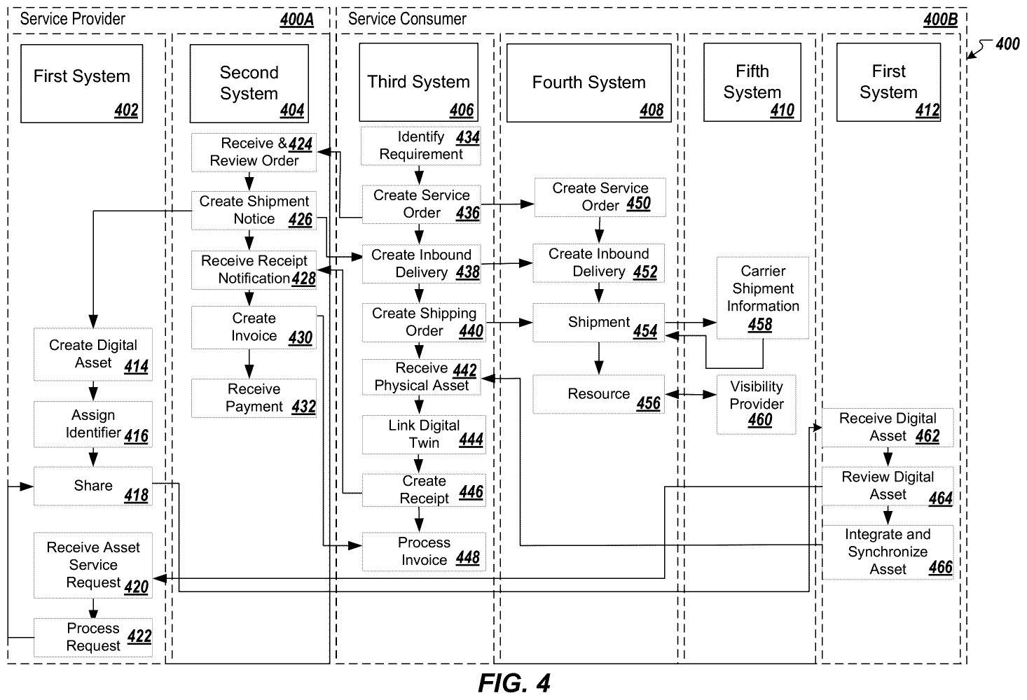

FIG. 4 depicts an example workflow 400 for service collaboration in accordance with implementations of the present disclosure. In some implementations, collaborative processes are described/executed in terms of parallel-executed service components. In some implementations, the example workflow 400 can represent the interaction between components of multiple systems of a system architecture (e.g., example system architecture 100 described with reference to FIG. 1) accessible by a service provider 400A and a service consumer 400B. The system architecture can include a first system 402 (e.g., first system 310 described with reference to FIG. 3), as second system 404 (e.g., second system 312 described with reference to FIG. 3), a third system 406 (e.g., third system 314 described with reference to FIG. 3), a fourth system 408 configured for global tracking and tracing of assets, and a fifth system 412 configured for providing logistic services. In general, the information flow 400 describes example steps to enable a user of the first system 404 to access services provided by the first system 404 to enable the data flow to other systems 406, 408, 410, 412 to monitor and optimize data flow, minimizing a risk of service deviation from service requirements with the use of digital assets.

In some implementations, systems 402, 404, 406, 408, 410, 412 can be ad-hoc invited to participate in the collaboration and can be bound to certain roles in the service process, as illustrated in FIG. 4. In some implementations, each service component has an associated lifecycle that describes the workflow of executing the particular service element. In some implementations, each step in the workflow 400 leads to the creation of so-called “action items” that are sent to one or more of the systems 402, 404, 406, 408, 410, 412 to perform at the service provider side 400A or at the service consumer side 400B. In some implementations, the possible ad-hoc composition of such service structures can be done by a service manager, using a digital asset, as part of the execution of a service planning, monitoring, tracking, and verifying action item.

For example, the first system at the service provider side 402 can create a digital asset (object or twin) corresponding to a physical asset 414. The digital asset can be created as a digital or virtual representation of the physical asset including all the existent and planned characteristics of the physical asset. The digital asset can be configured to enable two- or three-dimensional visualization of the current (as-is) physical asset (in a first view) and planned physical asset (in a second view). The digital asset can be created to include a detailed technical description of the physical asset, which can be accessed as a separate file or by selecting a displayed component of the visualized physical asset. In some implementations, the first system 402 can create a digital asset corresponding to a physical asset in response to receiving a shipment notice generated by the second system 404. The first system 402 can assign a digital identifier to the created digital asset to enable tracking of the digital asset during a service related to a corresponding physical asset 416. The first system 402 can share the digital identifier with any of the other connected systems 406, 408, 410, 412 to enable tracking of the digital asset during the service related to the corresponding physical asset 418. The first system 402 can be configured to receive, a request for a service for an existing asset (previously assigned to a digital identifier) 420. The first system 402 can process the request for the service 422 and share the digital identifier for the requested service with any of the other connected systems 406, 408, 410, 412 to enable tracking of the digital asset during the service related to the corresponding existing physical asset 418.

The second system 404 can receive an order for a service (e.g., asset purchase order) for a physical asset 424. In some implementations, the second system 404 receives the order for the service from the third system 406. The second system 404 can process the order for the service to create a shipment notice 426. The second system 404 can transmit the shipment notice to the third system 406. The second system 404 can receive, from the third system 406, a receipt notification 428. The second system 404 can process the receipt notification to create an invoice 430 and transmit the invoice to the third system 406. The second system 404 can be configured to receive and process a service compensation (e.g., payment) for a completed, verified, and approved service 432.

The third system 406 can identify requirements for services related to a new or existing asset, including services to manufacture, maintain and/or repair a physical asset corresponding to a model listed in an asset (object) list 434. The third system 406 can (automatically or semi-automatically) create service requisitions and requirements. The third system 406 can use the identified requisitions and requirements to create service (e.g., purchase) orders 436. The third system 406 can send the service orders to the second system 404 and to the fourth system 408 including service suppliers. The third system 406 can process the service orders and a shipment notice received from the second system 404 to create an inbound delivery notice 438. The third system 406 can use the inbound delivery notice to create a shipping order 440 that can be transmitted to the fourth system 408. The third system 406 can process a confirmation of a received physical asset 442. The third system 406 can process integration and synchronization results received from the first system 402 to link the digital asset to the received physical asset 444. In response to linking the digital asset to the received physical asset, the third system 406 can create a receipt for the completed service 446. The third system 406 can transmit the receipt for the completed service to the second system 404. The third system 406 can receive the invoice from the second system 404 and process the invoice. 448.

The fourth system 408 can receive a service order from the third system 406 and to create a service order to track and trace a digital asset 450 corresponding to a serviced physical asset. The fourth system 408 can create an inbound delivery notice for tracking and tracing the digital asset 452. The fourth system 408 can monitor shipment 454, by communicating with the fifth system 410, to track the physical asset and by updating the shipment information 458 of the digital asset based on actual events related to the physical asset, the actual events data being received by the fourth system 408 from the fifth system 410. The fourth system 408 can be configured to communicate with the fifth system 410 by sharing resource information 456 to increase visibility of logistical operations 460. In some implementations, simple delegation can be provided through the selection of resources. In some implementations, simple delegation enables a service element to be delegated to a specific resource, the resource taking over the responsibility for execution of that service element.

The service consumer side of the first system 412 can be configured to receive, from the service provider side of the first system 402, a digital twin 462. The service consumer side of the first system 412 can review the digital asset 464 to verify if the digital asset meets quality criteria according to the requested service for the respective physical asset. In response to determining that one or more portions of the criteria are not satisfied, the first system 412 can trigger an automatic request for an updated service to change one or more features of the digital asset (and consequently of the physical asset) to align the digital asset with the quality criteria. In response to determining that the digital asset satisfies the quality criteria, the asset can be integrated and synchronized in the backend of the service consumer system 400B.

In accordance with implementations of the present disclosure, collaboration objects include sharing a digital asset increase visibility of the process (e.g., workflow). In some implementations, an embedded process includes a sequence of action items. In some implementations, entities (e.g., engineers) are required to take an action based on a respective role that they play in the multisystem collaboration. In some implementations, an entity is notified of the action item to be performed, and provides a response when the action item is completed. Example action items for a project element can include: plan project (e.g., in terms of sub-projects and tasks), select resources, execute sub-project, execute task, validate sub-project results, and validate task results. As indicated by the above-provided example action items, action items need not be specific for the purpose of the work at hand, because the purpose of the work at hand is typically expressed in terms of the projects and tasks (e.g., design, commercialize, manufacture, and ship a vehicle), while the digital asset, and therefore the corresponding embedded workflow process reflects in real time a status of the respective physical asset. In some implementations, synchronization points are provided. In some implementations, a synchronization point indicates a point where the embedded service workflow for a physical asset and a respective digital asset waits for a status change in another collaborating system. In some implementations, synchronization points enable service structures to be ad-hoc planned and changed during execution of service processes.

As discussed in further detail herein, controlled service visibility can be fulfilled through generation and transmission of digital assets. In some implementations, the customer delegates a service related to a selected physical asset to a service provider (supplier). Upon acceptance of the service, the service provider has access to the initial instructions and receives access to the relevant data. The supplier can create a digital asset based on the physical asset and the requested service. The details of the service work are visible to the customer, in as far as the customer has read access to a service status using the digital asset. In some implementations, controlled data sharing can be provided in a scenario where the supplier accepts a service assigned by the customer, and receives access to references to initial data. In some implementations, a placeholder for the output results (projected features of physical asset at completion of service are included in the digital asset) are made available to the customer. The supplier uses input data for executing the service and copies the results of each portion of the service into the digital asset information until the service is completed.

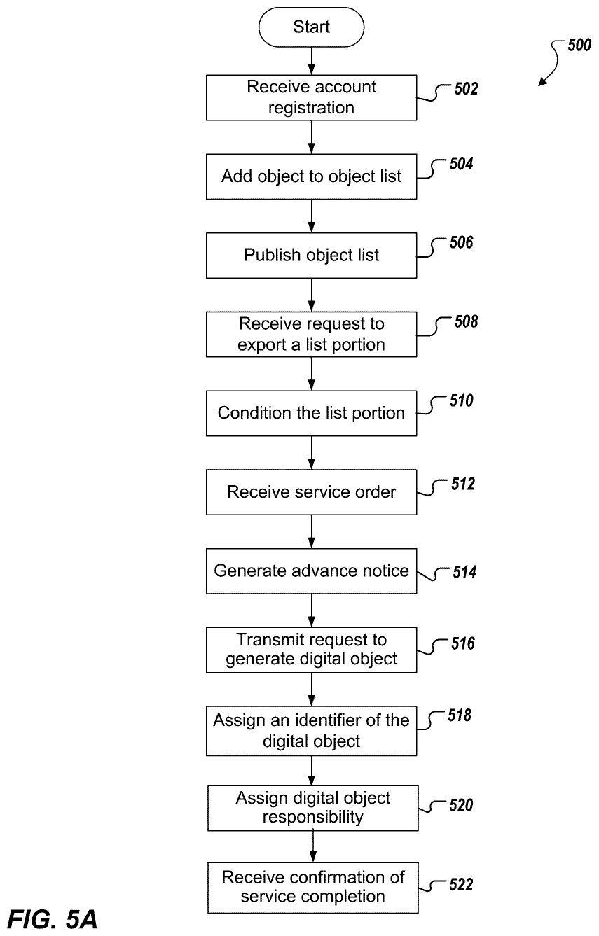

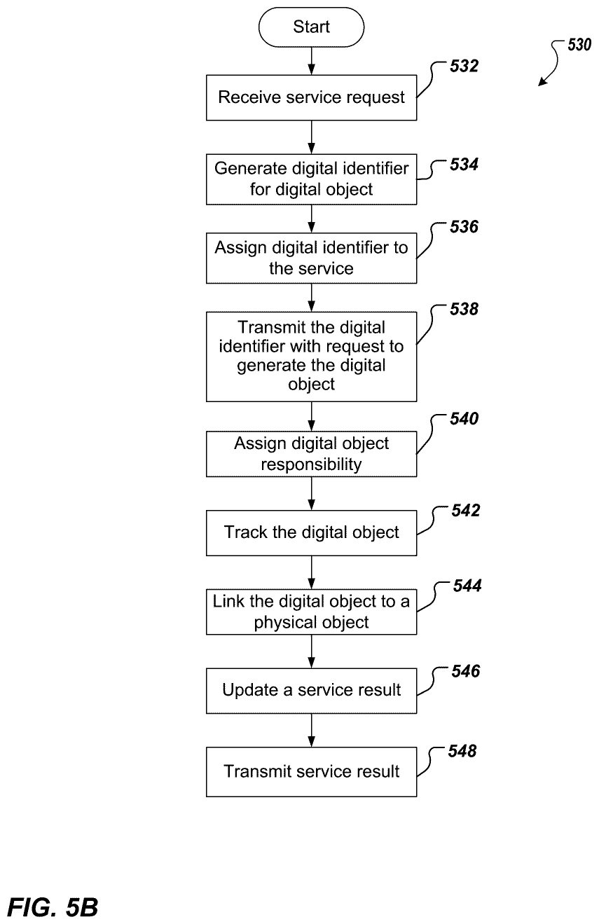

Referring now to FIGS. 5A and 5B example processes 500 and 530, respectively that can be executed in accordance with implementations of the present disclosure are depicted. In some implementations, the example processes 500 and 530 can be executed to provide support for service collaboration between multiple systems configured for automatic sharing capabilities of digital objects between two or more systems. In some implementations, the example processes 500 and 530 can be provided by one or more computer-executable programs that are executed by one or more computing devices. In some implementations, the example processes 500 and 530 can be provided as part of a computer-executable collaboration tool. In some implementations, a computer-executable collaboration tool can be provided in a client-server architecture. For example, user interfaces can be provided on one or more client computing devices for receiving user input. The user input can be transmitted to one or more server devices, which can process the user input as discussed herein.

As illustrated in FIG. 5A, a user input including a request for a registration of an account on a first system is received by a first system (e.g., a procurement system, such as system 312 described with reference to FIG. 3) (502). In some implementations, the user input defines the user as a provider for one or more services that enable collaboration between multiple systems including the first system, a second system (e.g., asset intelligence network (AIN) system 204 described with reference to FIG. 2 and first system 310 described with reference to FIG. 3) and a third system (e.g., an enterprise resource planning system, such as system 202 described with reference to FIG. 2 and such as system 314 described with reference to FIG. 3). In some implementations, the services include service elements, having an embedded process therein that supports data sharing and process-based collaboration between systems (e.g., as discussed with reference to, and depicted in FIGS. 2-4).

Objects (asset information related to assets) are added to an object list associated with the account on the first system (504). The object list is formatted for display by one or more computing devices within the first system. The object list includes model information retrieved from the second system coupled to the first system. The model information includes an identifier of a physical object (asset) and one or more characteristics of the physical object. In some implementations, the physical object can include one or more versions of a physical model (e.g., a basic model, and upgraded models with additional features), each version having a particular set of features and a unique asset identifier.

The object list (itemized catalog of assets) is published, by the first system, to be visible to a plurality of users (customers) accessing the first system, as service consumers, searching for one or more services (506). A request to export a portion of the object list to a third system is received from one of the users of the first system (508). In response to receiving the request, the portion of the object list is conditioned (510). Conditioning can include at least one of converting data based on a transmission protocol, formatting data for optimal display using an application of at least one of the second and third system, and packaging data for transmission to the third system. Conditioning can further include determining that the requested portion of object list is associated with model information stored in a model library accessible using a physical object identifier, the physical object identifier that can be cross-referenced to a digital object identifier to enable real-time tracking of the object status during the service.

A service order is received (512). The service order can include the model information associated with the physical object referenced in the portion of the object list. An advance notice for the service order is generated (514). A request to generate a digital object including at least one of technical specifications of the physical object, digital representation of spare components of the physical object, and recommended services for the physical object identified using the physical object identifier is transmitted (516). An identifier of the digital object for tracking the digital object during execution of a process of the service is assigned (518). A responsibility of managing and tracking the digital object during the process using the identifier of the digital object is assigned to an entity associated with any the multisystem architecture, such as the fourth system 408 described with reference to FIG. 4 (520). In some implementations, one or more sensors are attached to the physical object and any change in status of the physical object are automatically transmitted from the tracking system to the first system, to be accessible in real time through the digital object. In some implementations, delivery of a digital object that does not comply with one or more criteria or requirements of the selected service of a respective physical object, can trigger a process blocking mechanism (e.g., deactivation of a system function) to prevent generation of invoices. In response to receiving a confirmation of successful and compliant completion of the service order for the physical object referenced in the portion of the object list, a service completion certificate can be issued and transmitted to all systems that collaborated to perform the service (522). In some implementations, the confirmation of completion of the service order can trigger a closure of all service related statuses within the first system and one or more additional systems.

As illustrated in FIG. 5B, a request for a service for a physical object is received (532). In some implementations, the request is generated as a selection of an automatically generated recommended service. The recommended service can be generated using a machine learning algorithm configured to process service requirements listed in a user input, past (historical) service selections, and a list of available services for physical objects described in an object list.

A digital identifier is generated, by a first system, for a digital object (534). The digital object corresponds to a physical object included in an object list formatted for display by one or more computing devices within a first system. The digital object includes model information retrieved from a second system coupled to the first system. The model information includes an identifier of a physical object and one or more characteristics of the physical object.

The digital identifier of the digital object is assigned for the selected service to be performed on the physical object (536). Assigning can include: analyzing the model information to obtain a data feature corresponding to the model information and matching the model information based on the data feature to determine target service information that matches an existent digital identifier in a physical to digital identifier index or creating a new digital identifier, if no digital identifier corresponds to the identifier of the physical object. The digital identifier is transmitted to the second system with a request to perform the selected service related to the physical object (538).

A responsibility of managing and tracking the digital object during the process using the identifier of the digital object is assigned to an entity associated with any the multisystem architecture, such as a global track and trace system (540). In some implementations, one or more sensors are attached to the physical object and any change in status of the physical object are automatically transmitted from the tracking system to the first system, to be accessible in real time through the digital object. The digital object is tracked during a process by using the digital identifier (542).

The digital object is linked to a received physical object to handover of completed object information (e.g., master data for engineering and maintenance) (544). A service status and result can be automatically updated in real time (546). In some implementations, the first system and/or any of the systems collaborating with the first system to perform the service, can be configured to execute a service check using the digital asset, after completion of predetermined steps of the process or in response to receiving a trigger (e.g., asset information change trigger). The service result can be automatically transmitted to all systems that collaborated to perform the service (548). In some implementations, the confirmation of completion of the service order can trigger a closure of all service related statuses within the first system and one or more additional systems.

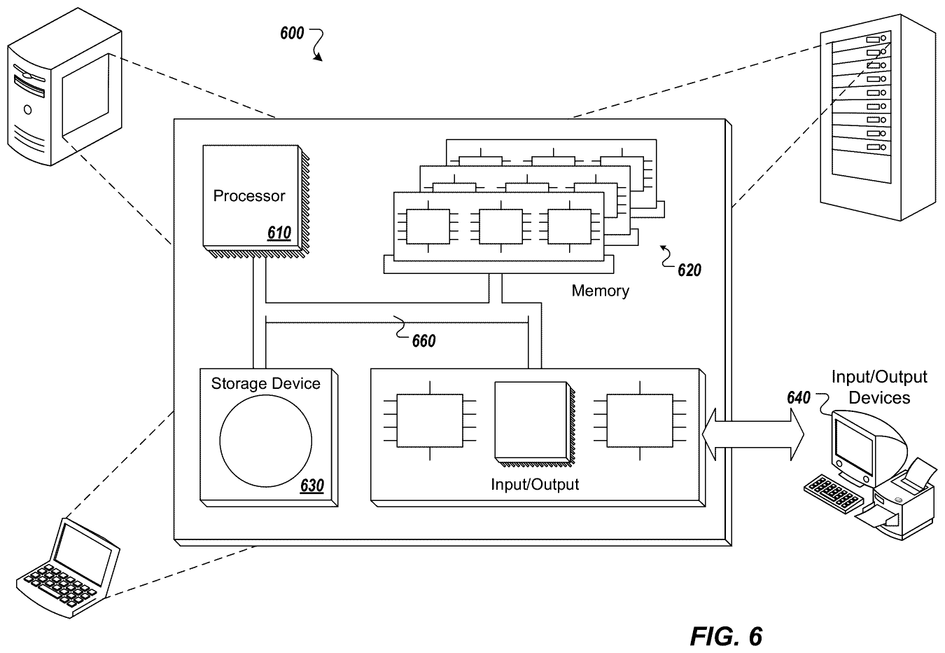

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit. The storage device 630 is capable of providing mass storage for the system 600. In one implementation, the storage device 630 is a computer-readable medium. In various different implementations, the storage device 630 may be a floppy disk device, a hard disk device, an optical disk device, or a tape device. The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed:

1. A computer-implemented method executed by one or more processors, the computer-implemented method comprising:
generating, by one or more processors, a digital identifier for a digital object corresponding to a physical object included in an object list formatted for display by one or more computing devices within a first system and comprising model information retrieved from a second system coupled to the first system, the model information comprising an identifier of a physical object and one or more characteristics of the physical object;
assigning, by the one or more processors, the digital identifier of the digital object to a service to be performed on the physical object;
transmitting, by the one or more processors to a second system, the digital identifier, the second system performing a service related to the physical object;
receiving, by the one or more processors to a second system, a service result related to the physical object; and
transmitting, by the one or more processors to a third system, the service result related to the physical object.

2. The computer-implemented method of claim 1, wherein assigning the digital identifier comprises:
analyzing, by the one or more processors, the model information to obtain a data feature corresponding to the model information; and
matching the model information based on the data feature to determine target service information that matches the digital identifier.

3. The computer-implemented method of claim 1, wherein the model information is visible for first system users and second system users.

4. The computer-implemented method of claim 1, further comprising:
transmitting, by the one or more processors to the second system, a request to generate the digital object corresponding to the physical object.

5. The computer-implemented method of claim 1, further comprising:
tracking, by the one or more processors, the digital object during a process by using the digital identifier.

6. The computer-implemented method of claim 5, further comprising:
assigning, by the one or more processors, a responsibility of managing and tracking of the digital object during the process using the identifier of the digital object.

7. The computer-implemented method of claim 1, further comprising:
linking, by the one or more processors, the digital object to the physical object received by an entity of the first system to generate a service notice.

8. A non-transitory, computer-readable medium storing one or more instructions executable by a computer system to perform operations comprising:
generating a digital identifier for a digital object corresponding to a physical object included in an object list formatted for display by one or more computing devices within a first system and comprising model information retrieved from a second system coupled to the first system, the model information comprising an identifier of a physical object and one or more characteristics of the physical object;
assigning the digital identifier of the digital object to a service to be performed on the physical object;
transmitting, to a second system, the digital identifier, the second system performing a service related to the physical object;
receiving, to a second system, a service result related to the physical object; and
transmitting, to a third system, the service result related to the physical object.

9. The non-transitory, computer-readable medium of claim 8, wherein assigning the digital identifier comprises:
analyzing the model information to obtain a data feature corresponding to the model information; and
matching the model information based on the data feature to determine target service information that matches the digital identifier.

10. The non-transitory, computer-readable medium of claim 8, wherein the model information is visible for first system users and second system users.

11. The non-transitory, computer-readable medium of claim 8, wherein the operations further comprise:
transmitting, to the second system, a request to generate the digital object corresponding to the physical object.

12. The non-transitory, computer-readable medium of claim 8, wherein the operations further comprise:
tracking the digital object during a process by using the digital identifier.

13. The non-transitory, computer-readable medium of claim 12, wherein the operations further comprise:
assigning a responsibility of managing and tracking of the digital object during the process using the identifier of the digital object.

14. The non-transitory, computer-readable medium of claim 8, wherein the operations further comprise:
linking the digital object to the physical object received by an entity of the first system to generate a service notice.

15. A computer-implemented system, comprising:
one or more computers; and
one or more computer memory devices interoperably coupled with the one or more
computers and having tangible, non-transitory, machine-readable media storing one or more instructions that, when executed by the one or more computers, perform operations comprising:
generating a digital identifier for a digital object corresponding to a physical object included in an object list formatted for display by one or more computing devices within a first system and comprising model information retrieved from a second system coupled to the first system, the model information comprising an identifier of a physical object and one or more characteristics of the physical object;
assigning the digital identifier of the digital object to a service to be performed on the physical object;
transmitting, to a second system, the digital identifier, the second system performing a service related to the physical object;
receiving, to a second system, a service result related to the physical object; and
transmitting, to a third system, the service result related to the physical object.

16. The computer-implemented system of claim 15, wherein assigning the digital identifier comprises:
analyzing the model information to obtain a data feature corresponding to the model information; and
matching the model information based on the data feature to determine target service information that matches the digital identifier.

17. The computer-implemented system of claim 15, wherein the model information is visible for first system users and second system users.

18. The computer-implemented system of claim 15, wherein the operations further comprise:
transmitting, to the second system, a request to generate the digital object corresponding to the physical object.

19. The computer-implemented system of claim 15, wherein the operations further comprise:
tracking the digital object during a process by using the digital identifier; and
assigning a responsibility of managing and tracking of the digital object during the process using the identifier of the digital object.

20. The computer-implemented system of claim 15, wherein the operations further comprise:
linking the digital object to the physical object received by an entity of the first system to generate a service notice.
